(19) United States
(12) Patent Application Publication
(10) Pub. No.: US 2012/0225163 A1
(43) Pub. Date: Sep. 6, 2012

(54) CHEWING GUM CONTAINER WITH DISPOSAL SHEETS

(75) Inventor: Fabien Guyot, Poisy (FR)

(73) Assignee: Cadbury France, Paris (FR)

(21) Appl. No.: 13/389,629

(22) PCT Filed: Aug. 24, 2010
(86) PCT No.: PCT/EP10/05179

§ 371 Date: Apr. 9, 2012

(30) Foreign Application Priority Data
Aug. 26, 2009 (GB) 0914898.2

(51) Int. Cl. A23G 4/18; B31B 1/62; B65D 85/00

(52) U.S. Cl. 426/5; 206/223; 493/128

(57) ABSTRACT

A chewing gum container (100) comprises a body (110) having an interior in which chewing gum pieces can be stored. A multiplicity of individual disposal sheets (12) for use in the disposal of spent gum is attached to a surface (114) of the container body. The sheets (12) are adhered together along an edge or edges (14, 16) in two or more locations and/or along at least half, but not all, of an edge or edges (14, 16) of the sheets, so that the multiplicity of individual sheets (12) form a stack (10). A method of manufacturing the container (100) with a stack (10) of sheets (12) attached is also disclosed.

### TECHNICAL FIELD OF THE INVENTION

The present invention relates to chewing gum containers. In particular, the invention relates to chewing gum containers which incorporate disposal sheets for use in the disposal of spent chewing gum.

### BACKGROUND TO THE INVENTION

Disposal of chewing gum can be problematic as the spent gum is often thrown onto the pavement—which is both unsightly and difficult to remove. Furthermore, some countries have strict laws governing the disposal of gum, which dictate that failure to dispose of gum in the correct manner can result in a penalty.

Some packs of chewing gum contain pieces of gum which are individually wrapped and whilst these wrappers can also be utilised to the wrap the spent chewing gum, the wrappers are often thrown away as soon as the gum has been removed. Other packs of chewing gum contain pieces of gum which are not individually wrapped and an individual therefore has to resort to using a redundant part of the pack or find a piece an alternative material (such as a tissue) in which to wrap the spent gum prior to subsequent disposal.

A number of gum containers have been developed which incorporate wrappers for spent gum. For example, WO2006029049 and JP9202370 disclose laminated sheets which are attached to the outer surface of chewing gum packaging for use in disposal of spent chewing gum. In certain embodiments, the sheets can be difficult to remove as they are located within pouches attached to the exterior of the packaging. In alternative embodiments, the sheets are exposed and they can therefore become easily damaged and/or dislodged from the packaging when handled or placed in a pocket or bag.

It is an aim of embodiments of the present invention to overcome one or more of the problems of the prior art. It is also an aim of the embodiments of the present invention to provide a chewing gum container having a number of disposal sheets which can be easily removed from the container, whilst not becoming damaged when the container is handled.

### SUMMARY OF THE INVENTION

In one embodiment of the present invention, there is provided a chewing gum container comprising a body having an interior in which chewing gum pieces can be stored, and a surface upon which is attached a multiplicity of individual disposal sheets for use in the disposal of spent gum, the sheets being adhered together along one or more edges of the sheet in two or more locations and/or along at least half, but not all, of the edge or edges of the sheets, so that the multiplicity of individual sheets form a stack.

The term “adhere together along one or more edges” includes embodiments in which an adhesive contacts and extends inwardly from the edge or edges, and also embodiments where the adhesive is spaced apart from the edge or edges.

The present invention provides a chewing gum container which has a number of disposal papers that can be easily removed when desired. The provision of adhering the edges together along two or more locations and/or along at least half, but not all, of the edge or edges of the sheets enables the uppermost sheet to remain substantially in place during handling of the container and thus reduce the risk of damage or displacement from the stack.

The sheets may comprise a cut-out along an edge or part of an edge which does not contain adhesive, so as to facilitate removal of individual sheets from the stack. In one embodiment, the cut-out has a curved profile. It will be understood by the skilled addressee that where cut-outs are provided, they will be profiled so as to facilitate the easy removal of individual sheets from the stack by the finger(s) of an individual.

The sheets may be adhered together along two or more edges which are not located adjacent to one another. Furthermore, the sheets may be adhered together along the edges in two or more opposing locations. In one embodiment, the sheets comprise four or more edges and the sheets are adhered along opposing edges. The sheets may be adhered by means of a glue or any other suitable adhesive.

The individual sheets may be adhered together in a number of configurations. For example, the sheets may be adhered together along at least part the edge(s), or adjacent sheets may be adhered along at least part of the edge(s) between the underside of a top sheet and a topside of a bottom sheet.

The sheets may be adhered together along the edges in two or more locations, and/or along at least half, but not all, of the edge or edges of the sheets, such that the adhesive contacts the edge(s). In an alternative embodiment, the sheets may be adhered together along the edges in two or more locations, and/or along at least half, but not all, of the edge or edges of the sheets, such that the adhesive is spaced away from the edge(s), but no more so than 20 mm, 15 mm, 10 mm, 5 mm, 2 mm or 1 mm The adhesive may be spaced away from the edge(s) in the range of 1 mm to 20 mm, 2 mm to 15 mm, 5 mm to 10 mm.

The individual sheets may be adhered together along the edges at two or more locations and/or towards at least half, but not all, of the edge or edges of the sheets by means of a strip or strips of adhesive extending substantially parallel with an edge. Such a strip may have a width from the edge of 2 cm or less. Each sheet may further comprise one or more perforations or tear lines positioned near to a portion of the sheet which been has adhered. Such perforations or tear lines will enable a portion of the sheet to be torn off when desired; leaving behind a “stub” on the stack.

The sheets may be adhered together along the edges at two or more locations and/or along at least half, but not all, of the edge or edges. The individual sheets may be adhered together by means of a continuous bead or continuous beads of adhesive. A number of adhesives used to bind sheets together (for example for note pads) will be evident to the skilled addressee. The edges of the sheets will commonly be adhered together by a straightforward adhesive edge for simply holding individual sheets of the stack together, allowing individual sheets to be torn off when desired. Alternatively, or additionally, the individual sheets may be adhered together by means of repositionable adhesive. It should be noted that the term “repositionable adhesive” refers to adhesive which is available that does not form a permanent bond with the object to which it is attached and therefore the sheet may be repositioned to other surfaces or positions. Such adhesives are commonly provided as a strip of adhesive on the rear of sticky notes (such as the “Post-It® Note” manufactured by 3M®) and it is the adhesive that permits the multiplicity of the sheets to be held together as a stack. The repositionable adhesive may be located on the underside of an individual sheet and may form the strip as herein above described.

In an embodiment of the present invention, the edges of the sheets are stacked directly in line with one another—so that the edges of a sheet are in alignment with the edges of an adjacent sheet. In an alternative embodiment, the sheets are stacked in a stepped configuration, so that at least one edge or part of one edge is offset from an edge of an adjacent sheet. If a stepped configuration is employed, the at least one edge or part of one edge offset from an adjacent sheet may incorporate the cut-out so as to facilitate removal of the uppermost sheet from the stack. The stepped configuration can also provide the added benefit of a thinner stack depending upon the number of sheets and the space between overlapping sheets.

It will be apparent to the skilled addressee that the sheets may be formed from a number of materials. For example, the sheets may comprise paper. In certain embodiments, the paper may be coated with a hydrophobic material (such as a wax) so as to prevent moisture from the spent gum passing through the sheet.

The sheets may be a number of shapes, but it is envisaged that it will not be wider (or have a diameter less) than 50 mm, and in some embodiments no more than 40 mm or 30 mm.

The stack may be adhered to a backing layer. The stack may be adhered to the surface by means of the backing layer. It will be apparent to one skilled in the art that the backing layer will usually comprise a material that is substantially more rigid than the material of the sheets. The backing layer may be formed from a number of materials, such a cardboard or a plastics material.

Advantageously, the surface of the body may comprise a recess which is adapted to receive at least part of the stack. This provision enables accommodation of the stack on the container without it protruding from the surface. The surface may be an exterior surface of the body. However, if desired, the body may further comprises a releasable lid for permitting access to the interior, and the lid may be provided with a recess adapted to receive at least part of the stack.

The container may contain various types of chewing gum, but is particularly suited to containing coated gum pieces (which are often unwrapped and found loose in containers). Coated gum pieces are well known in the art. The number of sheets may be substantially the same as the number of gum pieces if desired.

In a further embodiment of the present invention, there is provided a method of producing a chewing gum container, the method comprising the steps of

a) providing a container having an interior in which chewing gum pieces can be stored;

b) providing a stack of individual disposal sheets, the sheets being adhered together along at least a portion of an edge or edges of the sheets in two or more locations and/or along at least half, but not all, of the edge or edges of the sheets, so that the multiplicity of individual sheets form a stack; and

c) attaching the stack to a surface of the container.

The method may be for producing a container according to the first embodiment.

In a third embodiment of the present invention, there is provided a kit of parts for producing a chewing gum container, the kit comprising:
a) a container having an interior in which chewing gum pieces can be stored;
b) a stack of individual disposal sheets, the sheets being adhered together along at least a portion of an edge or edges in two or more locations and/or along at least half, but not all, of the edge or edges of the sheets, so that the multiplicity of individual sheets form a stack; and
c) means for attaching the stack to a surface of the container.

The kit of parts may also be for producing a container according to the first embodiment or used in the method of the second embodiment. The means for attaching the stack to a surface may comprise an adhesive layer.

### DETAILED DESCRIPTION OF THE INVENTION

A specific embodiment of the present invention will now be described, by way of example only, with reference to the accompanying drawings, in which:

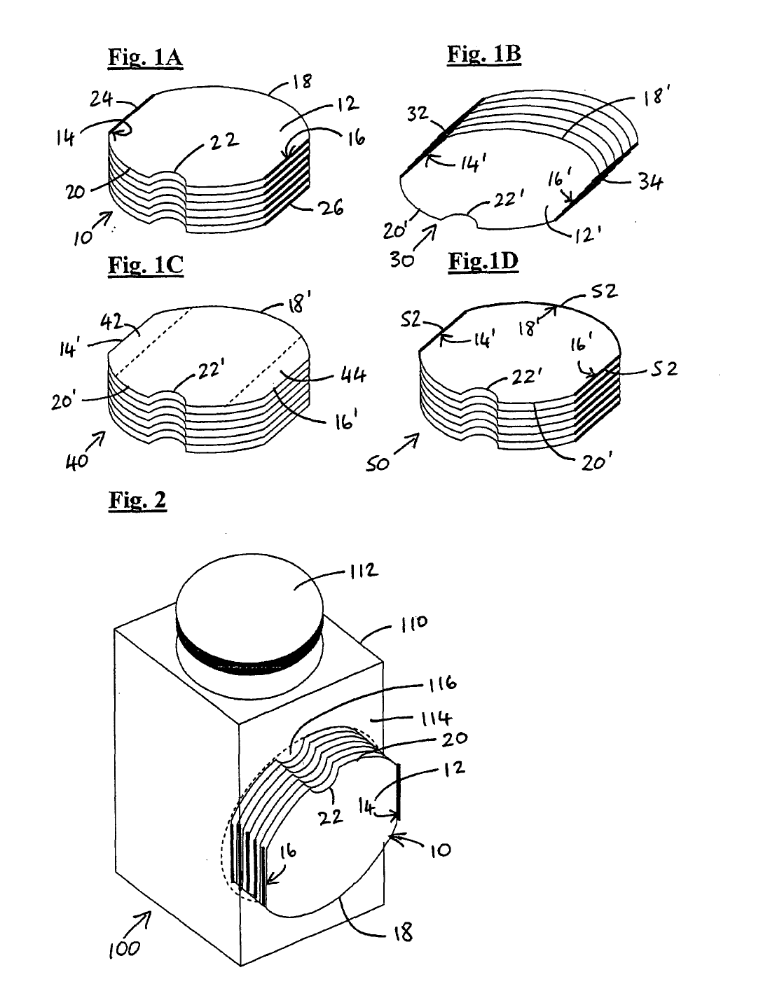

FIG. 1A is a perspective view of a stack of disposal sheets used in a first embodiment of the container according to the present invention, where the sheets are adhered together along two separate edges;

FIG. 1B is a perspective view of a stack of disposal sheets used in a second embodiment of the container of the present invention, where the sheets are in a stacked configuration and adhered together along two separate edges;

FIG. 1C is a perspective view of a stack of disposal sheets used in a third embodiment of a container of the present invention, where the sheets are in a stacked configuration and are attached to one another along two edges by means of repositionable adhesive;

FIG. 1D is a perspective view of a stack of disposal papers used in a fourth embodiment of a container according to the present invention where the sheets are in a stacked configuration and adhered together along three edges; and

FIG. 2 is a perspective view of a container according to the present invention which incorporates a stack of disposal papers as shown in FIG. 1A.

With reference to FIGS. 1A-1D, there is shown four separate embodiments of stacks of disposal papers which can be incorporated into the container of the present invention.

With reference to FIG. 1A, there is shown a stack of disposal sheets 10 which are formed from multiple planar sheets of paper having a uniform shape that are glued together along two edges. Each sheet 12 is of a generally square shape, having two opposing straight edges 14, 16, and two opposing curved edges 18, 20. At a point midway along one of the curved edges 20, is a semi-circular cut-out 22. A line of adhesive 24, 26, is attached along each straight edge 14, 16, to join the sheets together so as to form a stack.

With reference to FIG. 1B, there is shown a stack 30 of disposal sheets, where each sheet has an identical shape to the sheets shown in FIG. 1A, and similar features are indicated by the same reference number prime (′). Rather than the sheets being glued together so as to form a uniform stack, the sheets 12′ in FIG. 1B are glued along the straight edges 14′, 16′, so that each sheet is offset from an adjacent sheet by a pre-defined length. Lines of adhesive 32, 34, are located along the straight edges 14′, 16′, which are in line with one another, whereas the curved edges 18′, 20′, overlap one another in such a manner that the cut out 22′ does not overlap an adjacent sheet

The stack shown in FIG. 1C is similar to the stack shown in FIG. 1A, and again, similar features are indicated by the same reference number prime (′). However, rather than the sheets being glued together by means of a line of glue, the edges are attached to one another by means of a repositionable adhesive located on the underside of each sheet in an area denoted by a dotted line 42, 44, which runs parallel to the straight edge 14′, 16′.

With reference to FIG. 1D, there is shown a stack 50 which is a similar configuration to the stack shown in FIG. 1A, and similar features are indicated by the same reference number prime (′). However, in addition to lines of adhesive located along the straight edges 14′, 16′, the line of adhesive 52 runs along the rear curved edges 18′ also.

Turning to FIG. 2, there is shown a container 100 incorporating the stack 10 as shown in FIG. 1A. The container 100 is formed from a substantially cuboidal body 110, having a hinged lid 112 which provides access to its interior. Upon a front face 114 of the body, there is provided a recess 116 having a generally cylindrical profile. The stack of sheets 10 is attached within the recess 116 by means of an adhesive. If desired, a backing layer (not shown) may be formed on the underside of the stack 10 and this backing layer may be used to attach the stack within the recess. Whilst FIG. 2 shows that the stack 10 protrudes somewhat from the front face 114 of the body 110, the stack will usually be attached within a recess such that the stack does not protrude further than the front face 114 of the container so that the papers do not become damaged when the container is handled or transported. In an alternative embodiment (not shown), a stack of disposal papers can be incorporated into a recess on an outer surface of the lid 112, or in a yet further alternative embodiment, incorporated on the underside of the lid.

The sheets 12 can be manufactured from a number of materials, but will commonly be a paper material coated or impregnated with a hydrophobic material such as a wax, so that moisture from the spent chewing gum does not freely pass through the sheet when it is wrapped around spent gum.

In use, an individual would open the lid 112 of the container 100 in order to gain access to the interior, which contains a number of coated chewing gum pieces. After the individual has finished with the chewing gum, they would then insert their finger into the cut-away 22 and simply peel off a single disposal sheet which can then be used to wrap the chewing gum so that it can be disposed of accordingly. As the sheets of the stacks of FIGS. 1A, 1B and 1C are attached to one another by means adhesive along two edges, the sheets do not freely come away from the stack when being handled, and therefore the sheets do not become damaged or inadvertently removed during handling. The stack shown in FIG. 1D has a continuous adhesive line around at least half, but not all of the edge of the sheets, and as a reasonable amount of pressure is required to peel back an individual sheet, the sheets are less prone to damage. A further advantage shown in the stack of FIG. 1B is that depending upon the degree of overlap between adjacent sheets, the stack itself can occupy a reduced width which may be preferred for more compact gum containers, where space is an important consideration.

The gum container 100 can be manufactured from a number of materials, but will commonly be a plastics or cardboard material.

The foregoing embodiments are not intended to limit the scope of protection afforded by the claims, but rather to describe examples how the invention may be put into practice.

1. A chewing gum container comprising a body having an interior in which chewing gum pieces can be stored, and a surface upon which is attached a multiplicity of individual disposal sheets for use in the disposal of spent gum, the sheets being adhered together along an edge or edges in two or more locations and/or along at least half, but not all, of an edge or edges of the sheets, so that the multiplicity of individual sheets form a stack.

2. A container as claimed in claim 1, wherein the sheets comprise a cut-out along an edge or part of an edge which has not been adhered, so as to facilitate removal of individual sheets from the stack.

3. A container as claimed in claim 2, wherein the cut-out has a curved profile.

4. A container as claimed in claim 1, wherein the sheets are adhered along two or more edges which are not located adjacent to one another.

5. A container as claimed in claim 1, wherein the sheets are adhered together along the edges in two or more opposing locations.

6. A container as claimed in claim 1, wherein the sheets comprise four or more edges and the sheets are adhered together along opposing edges.

7. A container as claimed in claim 1, wherein the sheets are adhered together along the edges at two or more locations and/or towards at least half, but not all, of the edge or edges of the sheets by means of a strip or strips of adhesive extending parallel with an edge.

8. A container as claimed in claim 7, wherein the strip of adhesive has a width of 2 cm or less.

9. A container as claimed in claim 7, wherein each sheet further comprises one or more perforations or tear lines positioned near to a portion of the sheet which has been adhered.

10. A container as claimed in claim 1, wherein the sheets are adhered together by means of an adhesive which contacts the edge(s).

11. A container as claimed in claim 1, wherein the sheets are adhered together by means of an adhesive which is spaced away from the edge(s).

12. A container as claimed in claim 11, wherein the adhesive is spaced no more than 20 mm away from the edge(s).

13. A container as claimed in claim 1, wherein the individual sheets are adhered together by means of repositionable adhesive.

14. A container as claimed in claim 13, wherein the repositionable adhesive is located on the underside of an individual sheet.

15. A container as claimed in claim 1, wherein the sheets are adhered together along the edges at two or more locations and/or along at least half, but not all, of the edge or edges.

16. A container as claimed in claim 15, wherein the individual sheets are adhered together by means of a continuous bead or continuous beads of adhesive.

17. A container as claimed in claim 1, wherein the edges of the sheets are stacked directly in line with one another.

18. A container as claimed in claim 1, wherein the sheets are stacked in a stepped configuration, so that at least one edge or part of one edge is offset from an adjacent sheet.

19. A container as claimed in claim 18, wherein the at least one edge or part of one edge offset from an adjacent sheet incorporates the cut-out as claimed in claim 2.

20. A container as claimed in claim 1, wherein the sheets comprise paper.

21. A container as claimed in claim 1, wherein the stack is adhered to a backing layer.

22. A container as claimed in claim 21, wherein the stack is adhered to the surface by means of the backing layer.

23. A container as claimed in claim 1, wherein the surface of the body comprises a recess which is adapted to receive at least part of the stack.

24. A container as claimed in claim 1, wherein the surface is an exterior surface of the body.

25. A container as claimed in claim 1, wherein the body further comprises a releasable lid for permitting access to the interior, the lid having a recess which is adapted to receive at least part of the stack.

26. A container as claimed in claim 1, wherein the container contains coated gum pieces.

27. A method of producing a chewing gum container, the method comprising the steps of:
a) providing a container having an interior in which chewing gum pieces can be stored;
b) providing a stack of individual disposal sheets, the sheets being adhered together along the edges in two or more locations and/or along at least half, but not all, of the edge or edges of the sheets, so that the multiplicity of individual sheets form a stack; and
c) attaching the stack to a surface of the container.

28. (canceled)

29. A kit of parts for producing a chewing gum container, the kit comprising:
a) a container having an interior in which chewing gum pieces can be stored;
b) a stack of individual disposal sheets, the sheets being adhered together along an edge or edges in two or more locations and/or along at least half, but not all, of the edge or edges of the sheets, so that the multiplicity of individual sheets form a stack; and
c) means for attaching the stack to a surface of the container.

30.-31. (canceled)
